(19) United States
(12) Patent Application Publication
(10) Pub. No.: US 2011/0111083 A1
(43) Pub. Date: May 12, 2011

(54) USE OF XYLITOL FOR THE ECONOMIC IMPROVEMENT OF INTENSIVE PIG FARMING PRODUCTION

(76) Inventors: Manuel Milan Mesa, Barcelona (ES); Gabriel Marti Sandroma, Barcelona (ES); Sergio De Cozar Garcia, Barcelona (ES)

(21) Appl. No.: 12/613,838

(22) Filed: Nov. 6, 2009

(51) Int. Cl. A23K 1/18

(52) U.S. Cl. 426/2

(57) ABSTRACT

Use of xylitol for the economic improvement of intensive pig farming production, characterized by the presence of xylitol with a concentration of between 0.01% and 4% in the final feed.

### BACKGROUND OF THE INVENTION

In intensive pig farming the time taken to fatten up an animal is of vital importance, as the economic viability of the operation depends on it. Said timing being the least so that an animal reaches the sales weight depends on certain zootechnical factors amongst which the feed stands out. The feed is a central question in intensive production. It has been proven that the higher the intake of animal feed the higher are the transformation indexes of the food consumed into meat, and therefore the less time necessary to reach a suitable weight, hence the economic impact is double, on one hand the animals grow more with less feed and on the other hand, on reaching a suitable weight sooner, the occupation of the farm installations is less, both factors directly affecting the profitability of the process.

In regard to the peculiarities of the feeding, the rearing of pig farming can be divided into three phases that are easily distinguishable between each other from the differences in their characteristics: Lactation, weaning and feeding. The economic optimization of the animal breeding activity depends on the correct achievement of these three phases, that will produce healthy suckling animals and with a good weight, without deteriorating the weaning and, finally, with a faster feed period without lessening the health quality.

In the lactation phase of the animals the aim is to keep the lactating sows within the optimal zoo-technical parameters. In order to do this, the lactating sow must not stop drinking water and eating the feed that is necessary. The effect that the mid summer heat has on the lactating sows is well known in so far as the reduction of the appetite. The consequence of this is the failure to consume sufficient feed and/or water so as to maintain the production of milk, and as the suckling phase is a priority, the energy deficit is paid for with the loss of metabolic mass. The current pig breeds have been chosen by placing a high degree of importance on the criteria of prolificacy (number of piglets per pregnancy), hence the milk demand on the mother is higher and the problem is aggravated. The consequence of a reduction of the intake of feed once having exceeded a certain loss of weight, the sow delays the oestrus after the weaning and therefore, in spite of a good prolificacy, the number of annual pregnancies falls and with this the number of piglets, hence the productive indexes of the operation move away from that which is profitable.

The enzymatic system of the piglet is exclusively prepared to digest the nutrients contained in the sow's milk, the adaptation of the enzymatic system to a new diet is a dynamic process that takes time. The weaning when the animal is around three weeks old involves a harsh change from liquid feed to a solid diet, and a change from milk proteins and sugars to vegetables. This situation generates a period in which the animal is deficient in energy, and goes from growing fast to not growing and can even lose metabolic mass, up to the point of not ingesting the amount of feed necessary to satisfy its growth potential capacity. This critical phase of adaptation must be as short as possible and depends exclusively on the amount of feed ingested during these first hours. The longer the time that the adaptation to solid animal feed takes reduces the possibilities of optimum development. The deterioration suffered in this phase will be a permanently increased factor during the feeding of the animal.

During the feed phase, the greater the intake will mean greater performance of the pig rearing operation. But the current intensive pig farming is based on breeds of pigs that, even though over centuries have been the object of genetic selection, continue to have a limitation in their capacity to eat which is the main obstacle for the obtaining of all of their economic potential. Attempts have been made to overcome this obstacle, for example, by feeding the animal with concentrated diets, made up almost exclusively of cereals and pulses, and also by applying certain feeding strategies: Hours of availability of food and light, automatic feed dispensing, location of drinking troughs, etc. Also certain antibiotics have been used which, even though they do not have nutritional value, they affect the transformation of the feed into meat. All of these techniques together form the current attainable limit, but its satisfaction is not unanimous, for example some reduce the hours of sleep with the consequent tiredness of the animal, whilst others introduce medicines that are to be avoided.

Attempts have been made to solve the problems caused by the fall of the consumption in the reproducing sows and for the fall in the consumption in the weaning of the piglets, including in both cases the stress posed by the inclusion of new feeds for the animals. Some examples are quoted below.

Patent UA29235U deals with the problem of the reduction of the stress and the improvement of the productivity in the piglets, by means of the intramuscular administration of an inorganic chrome compound. U.S. Pat. No. 3,534,095 and U.S. Pat. No. 5,006,558 patents deal with solving the problem by administering magnesium salts. Patent JP2004135543 proposes the preparing of animal feed containing between 30% and 50% saccharides. Patent CN101223913 proposes an animal feed that improves the survival and growth of the piglets by means of the administration of liquid feed made from a lactose and plasma protein base and where some 50%-60% is fresh milk. Patent JP2001309752 proposes an animal feed for piglets with a palatability improvement that allows for an increase of the consumption and more rapid growth, made with products coming from an enzymatic egg hydrolysis. Patent JP3198750 describes a granulated feed for newly weaned piglets with a milk powder, cereal powder and rice vinegar base. Patent EP0457953 improves the feed palatability given to piglets by means of complex feed formation process, covered with sucrose, without the sucrose exceeding 6% in the final feed. Patent JP2004135543 proposes an animal feed made from 30%-50% dextrin, and with added saccharides which, in accordance with the patent, have a sweetness index of 20, in comparison to 100 for the pure sucrose. Patent JP2008253190 proposes an animal feed to encourage piglet growth which contains between 0.01% and 1% extract of Mormordica grosvenori. Patent CN1075852 proposes the addition of ground bone meal as an additive to increase the intake of food by the pigs, with all of the safety problems that this brings with it due to spongiform encephalopathy. Patent CN1072568 proposes an additive based on oligoelements, acetylsalicylic acid and furazolidone, which seems to increase the intake of feed somewhat. Patent EP0502931 proposes an animal feed free of chemical substances, hormones or antibiotics, but it must be accompanied by butter, skimmed milk and potatoes, which means a considerable cost increase for the feed.

All of the solutions quoted can provide a remedy to the problem of stress, palatability, or the improvement of the intake and/or growth of the piglets, but many of them have one or several disadvantages, such as substances must be administered with a pharmacological activity, or their administration is by intramuscular means, or that an extraordinary amount of sweetening substances must be added to the feed, or that complex processes have to be resorted to, or equally raw materials are used which considerably increases the cost of the final feed.

On the other hand, other solutions have been proposed for the economic improvement of intensive animal farming such as the following:

Patent CN1075852 proposes the addition of ground bone meal as an additive to increase the intake of food by the pigs, with all of the health problems that this brings with it due to the risk of spongiform encephalopathy. Patent U.S. Pat. No. 6,224,917 shows a method that uses calcium carbonate administered as a food supplement during the periods of strong animal growth so as to improve the bone metabolism; the calcium carbonate has to be accompanied by additives that specifically intervene in the bone metabolism of the calcium, specifically xylitol and ascorbic acid; one of the examples that it gives is with chicks and poultry which, as is well known, do not have a sense of taste, therefore, the effect of these additives does not have an effect on the intake of the food, but it does have an influence on the required incorporation of calcium into the skeleton. In patents ES 2201908 and EP 1462 101 it is proposed that the treatment of animals suffering from processes with fever, inflammation and pain be made by means of a galenic form that contains ketoprofen as main active agent prepared with diluting excipients such as poly-alcohols, from all of those stated as possible. In the documents ES P200802691, ES P200901651 and WO 2009000448, all belonging to the same owner as this present invention, the advantageous use of xylitol or its derivatives is revealed for the taste concealment of the chemical therapies of the quinolone-o-naftiridoncarboxilic acid group administered in feeds intended for pigs, feeds that in another way are clearly rejected, because of the strong bitter taste of said chemical therapies, bringing considerable weight loss in the animals with said rejection. Patent CN1072568 proposes an additive based on oligoelements, acetylsalicylic acid and furazolidone, which increases the intake of feed somewhat. Patent EP0502931 proposes an animal feed free of chemical substances, hormones or antibiotics, but it must be accompanied by butter, skimmed milk and potatoes, which means a cost increase for the feed.

### SUMMARY OF THE INVENTION

The use of xylitol or its derivatives to maximise the daily voluntary intake of animal food in intensive pig farming, understanding as food any substance with a nutritional value, including water.

### DETAILED DESCRIPTION OF THE INVENTION

This present invention provides a considerable improvement in the intensive pig farming operation taking into account the peculiarities that the feeding of said pigs presents in the three phases of its rearing, hence establishing a single food that is applicable to both the lactating sows and equally for the weaned piglets, and also the adults in the feed. The use of a single protocol naturally means a saving of resources and reduces possible mistakes and the consequences of them.

This invention consists of the use of small amounts of xylitol both in the drinking water and equally in the feed chosen for each one of the three phases. No other additive known, be it sugar, vitamin, antibiotic, etc. in similar concentrations and validity in the three phases shows the effect for pigs that was unexpected and not obvious on the complete acceptance of the feed that the pigs showed when the present invention is applied.

Xylitol is a sugar of a natural origin and in accordance with the merits of the present invention mixed with the corresponding feed in a final concentration of between 0.01% and 4% by weight, solves the lack of appetite of the lactating sows even in climatic conditions that are known as adverse, reducing or eliminating the reproductive problems arising from it. Due to the palatability, it also brings about the immediate acceptance of solid food by the recently weaned piglets, with which the above described disadvantages disappear. Finally, also because of the palatability, the presence of xylitol in the feed feed makes the adults consume a great deal more. The overall result has a high impact on the economic results of all of the productive process. The addition of xylitol in the proposed concentrations means a clear improvement in all of the productive process phases of the intensive pig farming operation, without placing either the quality of the meat or the health of the animals at risk.

The mixture of xylitol in the feed of the pig species allows the lack of appetite to be solved for the lactating sows during the feeding period for the piglets, reducing or eliminating the reproductive problems arising from it. The problems arising from a low intake of food during the critical moments of the weaning of the piglets are reduced or eliminated, making the uptake of a solid diet easier. And during the fattening phases, it allows the consumption of feed to be maximised where the growth is greater and therefore the conversion of the feed into meat is higher.

The clear improvement of the palatability of the feed for the pigs also allows feed to be made on the basis of the nutritional values of the components, with less restrictions conditioned by the lower palatability of the components, making up more economic portions but with an equivalent nutritional value, for example it allows the rate of the addition of sorghum to be appreciably increased.

The use of xylitol can go together with any other compound of a synergic effect with it, boosting the palatability of the feed or the aqueous dissolution or reducing the proportion of xylitol to be added. Some examples of the synergising product are acesulfame, alitame, aspartame, superaspartame, dulcin, monellin, neohesperidine dihydrochalcone, 5-nitro-2-propoxianilline, saccharine, sucralose, thaumatine, amino-acids such as arginine, glycine and tryptophan, or other sugars other than xylitol or glucosides such as those coming from Glycyrrhiza glabra or from Estevia rebaudiana, likewise the salts or compounds from any of them.

Under the terms of this present invention the xylitol can be added on its own or forming a part of a more complex preparation accompanied by any auxiliary excipient such as solvents and substances that make the solubility easier, preservatives, anti-oxidants, light protectors, colourings, reabsorption booster products, disintegration boosting agents, agglutinants, lubricants and stabilisers, depending on the final form of the product. Such formulations can be both dissolutions and equally solid preparations, intended to be mixed with feed and equally with the drinking water.

Therefore, the products arising from this present invention are all of those that contain xylitol, be they as the main substance or as an excipient, and are directly or indirectly intended for pig feed, including the drinking water, and an increase in the palatability arises from its use, and hence from the consumption.

According to the invention, the use of xylitol leads to an increase of the consumption of the normal food.

### PREFERRED EMBODIMENTS OF THE INVENTION

The following examples can be used to illustrate the invention, they must not be considered by being as limiting on the use of the applications of same.

### Example 1

### Fattening Pigs. Standard Feed with 0.25% Xylitol

The consumption is compared of two homogeneous pig groups of 12 animals, having some 35 kg. in weight over a 7 day period. One group fed with feed without xylitol, and one group fed with the same feed but containing 2,500 ppm of xylitol, which corresponds to 0.25% by weight.

| | | Average feed | Average feed | |
|---|---|---|---|---|
| | Total feed | consumed per | consumed per | |
| Corralina | consumed | animal | animal per day | Difference |
| Feed | 118.00 kg | 9.80 kg | 1.40 kg | — |
| WITHOUT | | | | |
| xylitol | | | | |
| Feed WITH | 134.00 kg | 11.16 kg | 1.60 kg | +14.29% |
| xylitol | | | | |

### Example 2

### Starter Piglets. Starter Feed with 0.25% Xylitol

The consumption of feed is compared for two groups of 25 animals having some 12 kg. weight, over the critical period of the first two days. One group fed with feed without xylitol, and one group fed with the same feed but containing 2,500 ppm of xylitol, which corresponds to 0.25% by weight.

| | | Average feed | Average feed | |
|---|---|---|---|---|
| | Total feed | consumed per | consumed per | |
| Corralina | consumed | animal | animal per day | Difference |
| Feed | 21.50 kg | 0.860 kg | 0.43 kg | — |
| WITHOUT | | | | |
| xylitol | | | | |
| Feed WITH | 25.00 kg | 1.00 kg | 0.50 kg | +16.28% |
| xylitol | | | | |

### Example 3

### Lactating Sows. Standard Feed with 0.25% Xylitol

The average consumption of the same feed with and without xylitol is compared in lactating sows, with the administration from day 10 up to day 15 of the feeding. The sows that ate feed without xylitol were housed in the left hand side of the farrowing pens, and the sows that ate the same feed with 2,500 ppm of xylitol were housed on the right hand side of the same pen. In total there were 15 sows per side.

Taking the importance of room temperature into account for the consumption of the animals, the daily maximums and minimums were recorded.

| | Mini- | Maxi- | | | Average | |
|---|---|---|---|---|---|---|
| | mum | mum | | Total | feed | |
| | T° | T° | | feed | consumed | % |
| Day | (° C.) | (° C.) | Feed | consumed | per animal | Difference |
| 1 | 14.4 | 27.4 | Feed | 78.15 kg | 5.21 kg | — |
| | | | WITHOUT | | | |
| | | | xylitol | | | |
| | | | Feed WITH | 91.50 kg | 6.10 kg | +17.08% |
| | | | xylitol | | | |
| 2 | 16.3 | 28.01 | Feed | 80.55 kg | 5.37 kg | — |
| | | | WITHOUT | | | |
| | | | xylitol | | | |
| | | | Feed WITH | 93.75 kg | 6.25 kg | +16.39% |
| | | | xylitol | | | |
| 3 | 14.5 | 26.4 | Feed | 79.50 kg | 5.30 kg | — |
| | | | WITHOUT | | | |
| | | | xylitol | | | |
| | | | Feed WITH | 92.25 kg | 6.15 kg | +16.04% |
| | | | xylitol | | | |
| 4 | 17.7 | 27.0 | Feed | 77.85 kg | 5.19 kg | — |
| | | | WITHOUT | | | |
| | | | xylitol | | | |
| | | | Feed WITH | 91.05 kg | 6.07 kg | +16.96% |
| | | | xylitol | | | |
| 5 | 16.9 | 26.8 | Feed | 79.05 kg | 5.27 kg | — |
| | | | WITHOUT | | | |
| | | | xylitol | | | |
| | | | Feed WITH | 92.40 kg | 6.19 kg | +16.89% |
| | | | xylitol | | | |

### Example 4

### Lactating Sows. Water Consumption with 0.25% Xylitol

In a farrowing pen similar to that described in example 3, the drinking water consumption was compared for the same 5-day period, from day 10 to day 15 of the feeding, in the same way the sows that drank water with xylitol were housed on the right hand side and the sows that drank water without xylitol on the left hand side. Each side had independent water troughs. In this case there were 22 sows per side. In a like manner the daily maximum and minimum temperatures were recorded.

| | | | | | | Average | | |
|---|---|---|---|---|---|---|---|---|
| | | | | Total | | water | | |
| | Mini- | Maxi- | | water | | consumed | | % |
| | mum | mum | | consump- | | per | | Differ- |
| Day | T° (° C.) | T° (° C.) | Feed | tion | | animal | | ence |
| 1 | 15.4 | 26.8 | Water | 442.2 | l | 20.1 | l | — |
| | | | WITHOUT | | | | | |
| | | | xylitol | | | | | |
| | | | Water WITH | 506.0 | l | 23.0 | l | +14.43 |
| | | | xylitol | | | | | |
| 2 | 14.3 | 27.2 | Water | 448.8 | l | 20.4 | l | — |
| | | | WITHOUT | | | | | |
| | | | xylitol | | | | | |
| | | | Water WITH | 517.0 | l | 23.5 | l | +15.20 |
| | | | xylitol | | | | | |
| 3 | 15.1 | 26.4 | Water | 455.4 | l | 20.7 | l | — |
| | | | WITHOUT | | | | | |
| | | | xylitol | | | | | |
| | | | Water WITH | 517.0 | l | 23.5 | l | +13.53 |
| | | | xylitol | | | | | |
| 4 | 17.6 | 27.6 | Water | 437.8 | l | 19.9 | l | — |
| | | | WITHOUT | | | | | |
| | | | xylitol | | | | | |
| | | | Water WITH | 501.6 | l | 22.8 | | +14.57 |
| | | | xylitol | | | | | |
| 5 | 18.0 | 27.5 | Water | 444.4 | l | 20.2 | | — |
| | | | WITHOUT | | | | | |
| | | | xylitol | | | | | |
| | | | Water WITH | 510.4 | l | 23.2 | | +14.85 |
| | | | xylitol | | | | | |

### Example 5

### Fattening Pigs. Fattening Feed with 0.25% Xylitol

The feed consumption for the two groups was compared, distributed in 30 pens of 12 animals having an average weight of 60 kg., fed with the same feed, 15 pens without xylitol and 15 pens with 2,500 ppm xylitol in the feed. The consumptions were noted for 30 days.

| | | Monthly | | | Monthly |
|---|---|---|---|---|---|
| | | consumption | | | consumption |
| Type of feed | Feed | (kg) | Type of feed | Feed | (kg) |
| WITHOUT | 1 | 859 | WITH | 16 | 981 |
| XYLITOL | 2 | 864 | XYLITOL | 17 | 986 |
| | 3 | 863 | | 18 | 985 |
| | 4 | 867 | | 19 | 992 |
| | 5 | 862 | | 20 | 987 |
| | 6 | 867 | | 21 | 989 |
| | 7 | 860 | | 22 | 985 |
| | 8 | 863 | | 23 | 990 |
| | 9 | 862 | | 24 | 988 |
| | 10 | 866 | | 25 | 985 |
| | 11 | 865 | | 26 | 993 |
| | 12 | 859 | | 27 | 990 |
| | 13 | 862 | | 28 | 983 |
| | 14 | 865 | | 29 | 988 |
| | 15 | 860 | | 30 | 991 |

| | | | |
|---|---|---|---|
| Total | 12,944 kg | Total | 14813 kg |
| Average | 2.40 kg | Average | 2.74 kg |
| consumption per | | consumption per | |
| animal per day | | animal per day | |

| | Total monthly consumption | |
|---|---|---|
| | (kg) | Difference |
| WITHOUT xylitol | 12944 | — |
| WITH xylitol | 14813 | 14.44% |

1. Use of xylitol for the economic improvement of intensive pig farming production, characterized by the presence of xylitol with a concentration of between 0.01% and 4% in the final feed.

2. Use of xylitol, in accordance with claim 1, characterized by its use in the feed of lactating sows.

3. Use of xylitol, in accordance with claim 1, characterized by its use in the feed of weaning pigs.

4. Use of xylitol, in accordance with claim 1, characterized by its use in the feed in fattening pigs.

5. Use of xylitol, in accordance with claim 1, characterized for considering the water specifically as feed.

6. Use of xylitol, in accordance with claim 1, characterized for using xylitol as both a main substance and also as an excipient.

7. Use of xylitol in the pig feed in accordance with the above claims, characterized by leading to an increase of the consumption of the normal food.
